(19) United States
(12) Patent Application Publication
(10) Pub. No.: US 2013/0075640 A1
(43) Pub. Date: Mar. 28, 2013

(54) LEARNING MECHANICAL STOPS IN A NON-RIGID INTERMEDIATE GEAR

(71) Applicant: Robert Bosch GmbH, Stuttgart (DE)

(72) Inventors: Alex Grossmann, Leonberg (DE); Torsten Baumann, Eppingen-Adelshofen (DE)

(73) Assignee: Robert Bosch GmbH, Stuttgart (DE)

(21) Appl. No.: 13/625,740

(22) Filed: Sep. 24, 2012

(30) Foreign Application Priority Data
Sep. 28, 2011 (DE) 10 2011 083 590.3

(51) Int. Cl. G01M 15/04; F16K 31/53

(52) U.S. Cl. CPC G01M 15/042; F16K 31/535
USPC 251/248; 73/114.77

(57) ABSTRACT

A method for determining information regarding a final position of an element of a gear, in particular a drive gear wheel, the information regarding the final position representing a stop position of a throttle valve at a mechanical stop, includes moving the element from a starting position in the direction of the final position, until the element comes to a standstill despite a specified supply of drive energy; determining information regarding the position of the element at standstill despite the supply of drive energy; and determining the information regarding the final position in that information of a correction distance is applied to the information regarding the position of the element, in particular subtracted, counter to the direction of the final position at standstill despite the supply of drive energy.

### CROSS REFERENCE TO RELATED APPLICATION

The present application claims priority to Application No. DE 10 2011 083 590.3, filed in the Federal Republic of Germany on Sep. 28, 2011, which is expressly incorporated herein in its entirety by reference thereto.

### FIELD OF INVENTION

The present invention relates to a method for determining information regarding a final position of an element of a gear, a device for determining information regarding a final position of an element of a gear, and a drive having the device.

### BACKGROUND INFORMATION

The freedom of movement of a throttle valve is delimited by mechanical stops. These mechanical stops must be known in order to regulate the position of the throttle valve.

Usually, the mechanical stops are learned in that the positional control moves the throttle valve against the mechanical stops until the position of the throttle valve is no longer able to comply with the positional setpoint value, and the actuating signal from the control, and thus the drive energy for moving the throttle valve, becomes increasingly greater. If the drive energy exceeds a particular threshold value, the current positional setpoint value is stored as the position of the mechanical stop and utilized to delimit the positional control.

However, it has become apparent that the position of the throttle valve is set imprecisely using the known stops and that, for example, the throttle valve supplies an incorrect air mass to an internal combustion engine.

### SUMMARY

A method for determining information regarding a final position of an element of a gear is provided, as well as a device and a drive.

According to one exemplary aspect of the present invention, a method for determining information regarding a final position of an element of a gear, especially a drive gear wheel, the information regarding the final position representing a stop position of a throttle valve at a mechanical stop, comprises the following steps:
moving the element from a starting position in the direction of the final position, until the element comes to a standstill despite a specified supply of drive energy;
determining information regarding the position of the element at standstill despite the supply of drive energy; and
determining the information regarding the final position in that information about a correction distance is applied to, especially subtracted from, the information regarding the position of the element, counter to the direction of the final position, at standstill despite the supply of drive energy.

The method is based on the notion that the gear for driving the throttle valve does not have an ideal rigidity. Furthermore, the present invention recognizes that the position sensors of the throttle valve are frequently situated on an element of the gear, such as the drive gear wheel. Therefore, if the throttle valve is moved in the direction of the mechanical stops, the stopping point for the element of the gear is able to be determined only when the element of the gear is no longer rotating. At this time, however, the throttle valve is already pressing against the mechanical stop with high force and, without the mechanical stop, would be positioned behind the stop, by a particular excursion differential. If this stopping point for the element of the gear thus defined is used as the basis for the positional control of the throttle valve, the throttle valve is always placed next to its actual position, by the distance of the excursion differential, which leads to the aforementioned inaccurate positioning. In the present invention the determined stopping point of the gear is therefore corrected, in that it is moved away again from the mechanical stop by a correction distance. This makes the positional control of the throttle valve more precise.

According to another exemplary aspect of the present invention, a device for determining information regarding a final position of an element of a gear, especially a drive gear wheel, the information regarding the final position representing a stop position of a throttle valve at a mechanical stop, comprises the following features:
a drive device for moving the element from a starting position in the direction of the final position, until the element comes to a standstill despite a specified supply of drive energy;
a measuring device for determining information regarding the position of the element during standstill despite the supply of drive energy; and
the measuring device being provided to determine the information regarding the final position, in that information regarding a correction distance is applied to, especially subtracted from, the information regarding the position of the element, counter to the direction of the final position, during standstill despite the supply of drive energy.

The measuring device may be equipped with a comparison unit which is suitable to determine standstill, to ascertain the drive energy, and to output an event indicating standstill when the drive energy has reached a threshold value or exceeds it. The threshold value for the drive energy ensures that the standstill of the gear is measured, but without running the risk that the connection between the element of the gear and the throttle valve will fracture because of an excessive supply of drive energy.

The measuring device may be suitable for subtracting the indicated correction distance so as to reduce the threshold value, and the drive unit may be suitable for returning the gear to the starting position, until the drive energy reaches the reduced threshold value or drops below it. This makes it possible to read out the corrected limit value again, directly at the position sensor of the positional control circuit.

In one alternative development, the measuring device may be provided to determine the information regarding the final position, based on the information regarding the position after the drive energy has reached the threshold value or has exceeded it, or after it has reached the reduced threshold value or has dropped below it. In this way the sensor of the positional control circuit, which feeds back the controlled variable, is able to be used for determining and storing the final position, so that redundancies in the system are avoided.

The measuring device may be suitable for storing the information regarding the position of the gear prior to the movement back to the starting position, and for performing a plausibility check of the determined information regarding the final position based on a difference between the determined information regarding the final position and the stored information regarding the position. Errors that may occur, for instance, in the drive-energy transmission between a drive energy source, e.g., a motor, and the element of the gear are able to be discovered in this way.

The measuring device may be suitable for the plausibility check to compare the difference to a difference stored in the measuring device. This difference may be predefined, so that the plausibilization is able to be performed in a simple manner with the aid of the comparison unit, which is already utilized for the purpose of determining the standstill of the drive gear wheel.

The stored difference may represent the movement of the element in a characteristic curve over the reduced drive energy, the characteristic curve contrasting the drive energy with the information regarding the position of the element when the throttle valve is at standstill. Since the absolute values of the drive energy prior to the correction and following the correction are known, a value for an expected difference is easily able to be found in the characteristic curve, which means that, for the plausibilization, the measured difference simply needs to be compared to the expected difference.

According to another exemplary aspect of the present invention, a drive for a throttle valve includes:
a motor;
a gear, moved by the motor, for moving the throttle valve; and
an indicated device for determining information regarding the final position of an element of the gear when the throttle valve strikes a mechanical stop.

The drive may have a butterfly valve shaft, which is connected to the gear, and on which the throttle valve may be mounted. This butterfly valve shaft distorts after it strikes the mechanical stop and is the main cause of the faulty determination of the information regarding the final position. As a result, the present invention may be used to especially good effect in such a device.

The measuring device is able to be used for determining the information regarding the correction distance, for measuring the indicated position of the element at standstill despite the supply of drive energy, and for rotating the element counter to the direction of the final position until the butterfly valve shaft is no longer distorted, so that the precise information regarding the final position of the element for the stop position of the throttle valve is able to be determined under ideal conditions, without deviations.

### BRIEF DESCRIPTION OF THE DRAWINGS

Exemplary embodiments of the present invention are explained in greater detail in the following text with reference to the accompanying drawings.

FIG. 1 shows a schematic illustration of a throttle valve restricted in its movement.

FIG. 2 shows a schematic view of a drive having a throttle valve.

FIG. 3 shows a schematic view of a control circuit for positioning a throttle valve using a device according to a first exemplary embodiment of the present invention.

FIG. 4 shows a method according to a first exemplary embodiment of the present invention.

FIG. 5 shows a method according to a second exemplary embodiment of the present invention.

FIG. 6 shows a characteristic curve, in which the resulting position of a throttle valve having the drive from FIG. 2 is shown over the drive energy.

FIG. 7 shows a schematic view of a control circuit for positioning a throttle valve using a device according to a second exemplary embodiment of the present invention.

FIG. 8 shows a method according to a third exemplary embodiment of the present invention.

### DETAILED DESCRIPTION

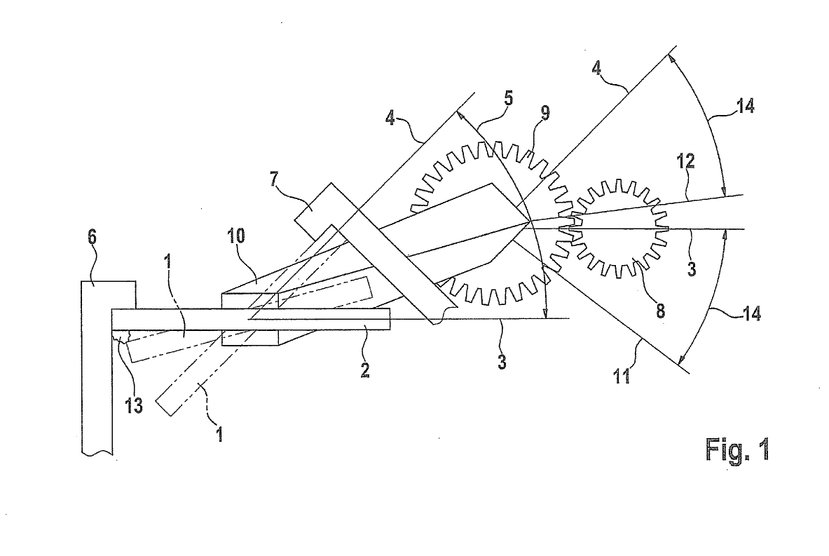

Reference is made to FIG. 1, which shows a throttle valve 1. Throttle valve 1 is pivotably accommodated inside a throttle housing 2 and is able to be freely positioned within a positioning range 5 between a lower stop position 3 and an upper stop position 4. At lower stop position 3, the movement of throttle valve 1 is stopped by a first mechanical stop 6, and at the upper stop position 4, it is stopped by a second mechanical stop 7.

First mechanical stop 6 of lower stop position 3 usually defines a position of throttle valve 1 for an idling state of a vehicle. Second mechanical stop 7 of upper stop position 4 usually restricts a maximally requestable output of the vehicle, e.g., when a motorized bicycle is to be throttled for the driver for reasons of traffic safety, and it therefore defines the full throttle position of throttle valve 1.

Throttle valve 1 is driven via a drive pinion 8. Drive pinion 8 transmits a torque to a drive gear wheel 9, which is mounted on top of a butterfly valve shaft 10. In this way throttle valve 1 is able to be pivoted back and forth between lower stop position 3 and upper stop position 4.

If throttle valve 1 is positioned with the aid of a control circuit, which is going to be described in the further text, it must, as a minimum, be provided with the information of the location of lower stop position 4, since the control circuit determines a setpoint position of throttle valve 1 in relation to lower stop position 3. If lower stop position 3 is incorrect, throttle valve 1 will be positioned at incorrect opening angles and supply an incorrect air quantity to an internal combustion engine, so that inaccurate outputs are called up. For example, this may affect other control circuits that intervene in the engine output of the vehicle, such as the electronic stability program or charge compensation, which is necessary for optimal fuel consumption.

Lower and upper stop positions 3, 4 are usually determined in that the control circuit runs through the full positioning range 5 of throttle valve 1 and checks at which position no further torque is transmittable from drive gear wheel 9 to throttle valve 1, and drive gear wheel 9 is no longer able to be rotated further. Throttle valve 1 is firmly resting against one of mechanical stops 6, 7 in that position.

However, butterfly valve shaft 7 is not infinitely rigid and is distorted when drive gear wheel 9 positions throttle valve 1 against mechanical stops 6, 7. Drive gear wheel 9 therefore continues to rotate when lower or upper stop position 3, 4 has been reached. Lower final position 11 or upper final position 12 of drive gear wheel 9, starting from which drive gear wheel 9 is no longer rotating, therefore does not correspond to the actual lower or upper stop positions 3, 4, respectively. The problems get worse when the force required to achieve stop positions 3, 4 increases due to contamination 13 at mechanical stops 6, 7, and butterfly valve shaft 10 becomes more distorted because of the higher torque.

In the present invention, lower final position 11 or upper final position 12 of drive gear wheel 9 is therefore recorded and a correction distance 14 is deducted therefrom in order to place lower final position 11 or upper final position 12 of the drive pinion at, respectively, the lower or upper stop positions 3, 4 of throttle valve 1.

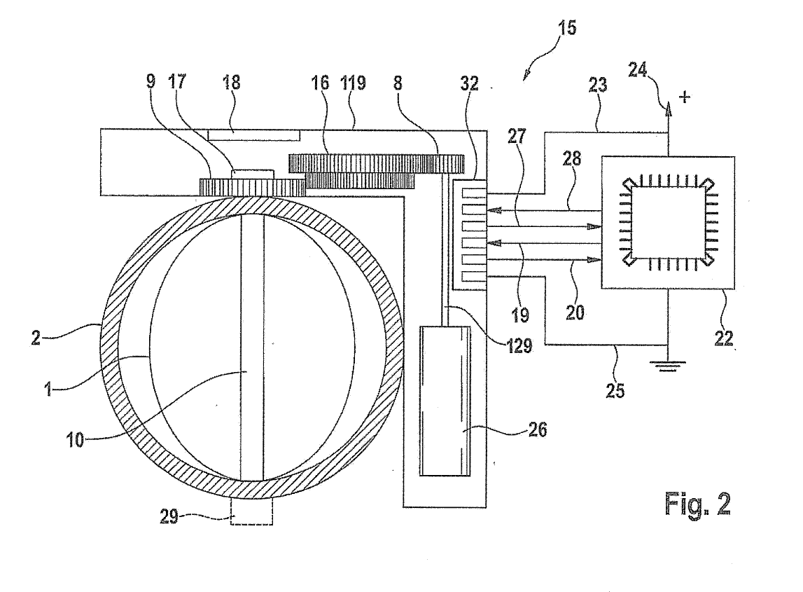

FIG. 2 shows drive system 15 for driving throttle valve 1. Elements in FIG. 2 that are identical to elements in FIG. 1 are denoted by the same reference numerals and not described again.

In drive system 15, the torques for throttle valve 1 are transmitted from drive pinion 8 to drive gear wheel 9, via a gear 16. A position sensor 17, 18 composed of two elements is situated on drive gear wheel 9. First part 17 of position sensor 17, 18 is mounted on drive gear wheel 9, while second part 18 of position sensor 17, 18 is disposed on a housing 119 of drive system 15.

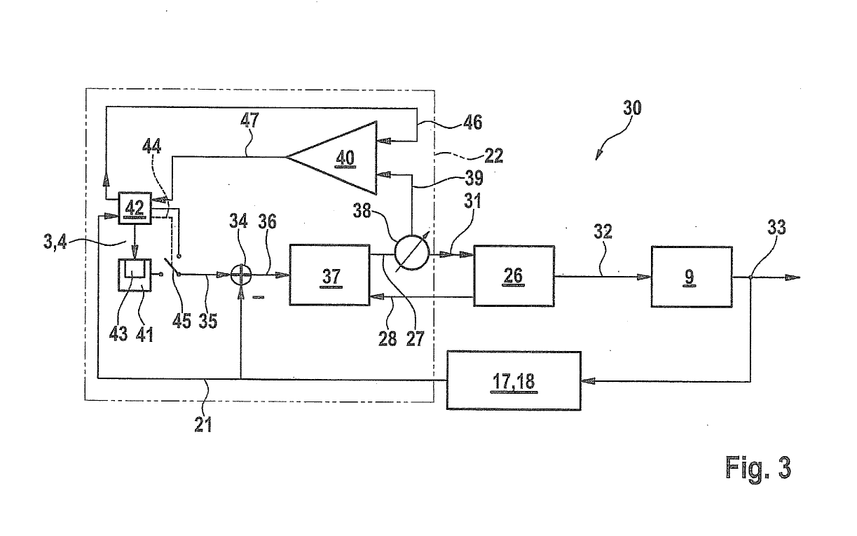

In the following text, a potentiometer 17, 18 is to be considered for position sensor 17, 18. In this case, first part 17 of position sensor 17, 18 may be a slider 17, and second part 18 of position sensor 17, 18 may be a potentiometer track 18, along which slider 17 is moving while throttle valve 1 is rotating. If a positive potential 19 is applied at slider 17, which generates a current directed into potentiometer 17, 18, and if a negative potential 20 is applied at potentiometer track 18, which generates a current directed out of potentiometer 17, 18, a measurable and variable potentiometer voltage 21 drops at potentiometer 17, 18, which is illustrated in FIG. 3. As an alternative to potentiometer 17, 18, it is also possible to use a Hall-effect sensor or an incremental sensor for measuring the position of drive gear wheel 9.

Lower and upper stop positions 3, 4 are determined in a processor 22, which, similar to drive system 15, is connected to a supply voltage 24 via a potential line 23 and connected to ground via a ground line 25.

Potentiometer voltage 21 indicates the position of drive gear wheel 9 to processor 22. In the undistorted state of butterfly valve shaft 10, the position of drive gear wheel 9 corresponds to the position of throttle valve 1. This allows a check in processor 22 during closed-loop control as to whether throttle valve 1 has reached a predefined setpoint position. If necessary, a positive electrical potential 27 and a negative electrical potential 28 are applied at a motor 26 in order to rotate throttle valve 1 via drive pinion 8 mounted on top of a motor shaft 129 of motor 26, until the setpoint position has been achieved. The arrows of potentials 27, 28 applied at motor 26 indicate the direction of the current produced by potentials 27, 28.

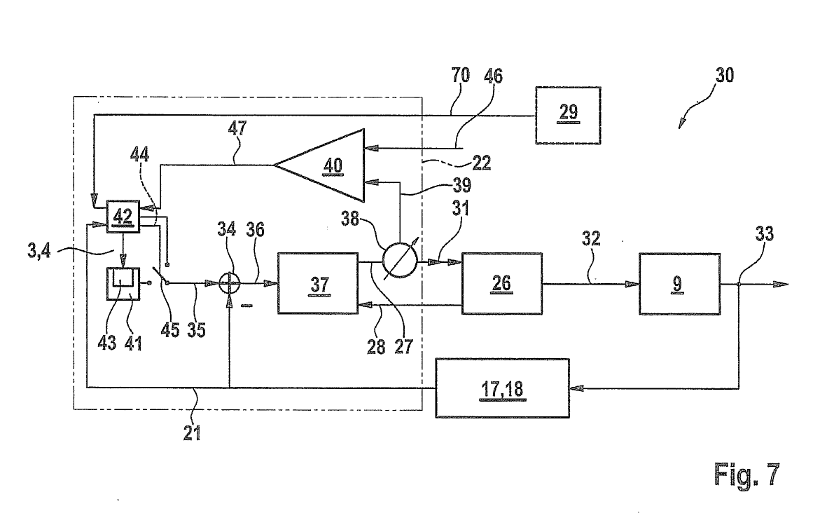

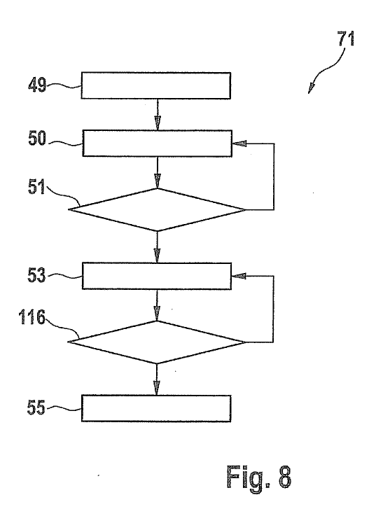

To measure the deformation of butterfly valve shaft 10, a second position sensor 29 may be mounted on the side of butterfly valve shaft 10 situated opposite from position sensor 17, 18, which then detects a position of butterfly valve shaft 10 on this side of butterfly valve shaft 10. The use of second position sensor 29 is discussed in greater detail in FIGS. 7, 8.

FIG. 3 shows a schematic view of a control circuit 30 for positioning throttle valve 10 with the aid of a device according to a first exemplary embodiment of the present invention. Elements in FIG. 3 that are identical to elements in FIGS. 1 and 2 are denoted by the same reference numerals and not described again.

In FIG. 3 the device is realized by a program running in processor 22 of FIG. 2, which digitally calculates lower and upper stop positions 3, 4. As an alternative, however, the device may also be implemented as circuit, which determines lower and upper stop positions 3, 4 by analog signal conversions.

Electrical potentials 27, 28 applied at motor 26 cause a current 31 through motor 26, which outputs a torque 32 to drive pinion 8. Drive pinion 8 moves drive gear wheel 9 via gear 16, so that torque 32 generated by motor 26 is acting directly on drive gear wheel 9. This causes drive gear wheel 9 to change its actual position 33, which is detected by position sensors 17, 18 and fed back to processor 22 via potentiometer voltage 21.

In processor 22, potentiometer voltage 21 is compared in a summation unit 34 to a setpoint voltage 35, which corresponds to the setpoint position of throttle valve 1, and a system deviation 36 is determined.

System deviation 36 is output to a controller 37, which uses it as the basis for calculating electrical potentials 27, 28 for motor 26 and applies them to motor 26. Motor current 31 produced by electrical potentials 27, 28 is recorded by a current measuring device 38, and its value 39 is output to a comparator 40.

Setpoint voltage 35 may be output from a control unit 41 and a measuring unit 42. While control unit 41 is provided to supply setpoint voltage 35 during standard operation of throttle valve 1, measuring unit 42 is provided to supply setpoint voltage 35 during an initialization phase in which stop positions 3, 4 are determined. During standard operation, control unit 41 is able to call up stop positions 3, 4 from a control memory 43, these positions having previously been determined by measuring unit 42 during the initialization phase and stored in control memory 43. A switch 45, controlled by measuring unit 42 via an enable signal 44, can be used to enable standard operation following the initialization phase.

To determine stop positions 3, 4, measuring unit 42 is able to record potentiometer voltage 21. To determine stop positions 3, 4, comparator 40 compares current value 39 of motor current 31 to a stop threshold value 46 and outputs a stop signal 47 if current value 39 of motor current 31 exceeds threshold value 46. Stop threshold value 46 may be specified by measuring device 42. Stop threshold value 46 defines a current value 39 for motor current 31, at which drive gear wheel 9 is unable to change its position 33 despite torque 32 supplied by motor 26. Stop threshold value 46 has been selected high enough so that throttle valve 1 is even able to compress and overcome contamination 13 at mechanical stops 6, 7, and thus is able to rest directly against mechanical stops 6, 7.

The output of stop signal 47 from comparator 40 indicates that drive gear wheel 9 has attained its lower or upper final position 11, 12, respectively. Measuring unit 42 is able to detect current potentiometer voltage 21 and correct it by a value that corresponds to correction distance 14. Corrected potentiometer voltage 21 may finally be stored in control memory 43 as a measure of one of stop positions 3, 4.

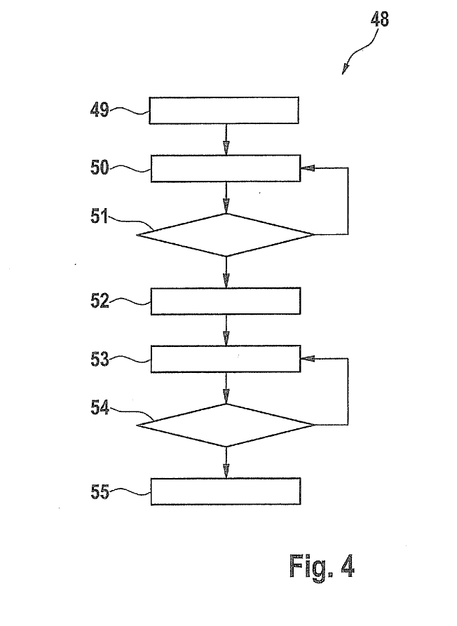

The correction of potentiometer voltage 21 will be described in the following text within the framework of an initialization method 48 according to a first exemplary embodiment of the present invention, based on FIG. 4.

In step 49, measuring unit 42 sets setpoint voltage 35 to an initial value, which corresponds to an initial setpoint position of throttle valve 1 between the two stop positions 3, 4, and throttle valve 1 is moved to the initial setpoint position via control circuit 30.

In step 50, setpoint voltage 35 is varied in order to determine a new position for throttle valve 1, which position lies closer to one of the two stop positions 3, 4. Depending on whether upper stop position 3 or lower stop position 4 is to be found, measuring unit 42 increases or decreases the value of setpoint voltage 35 by an increment for this purpose.

In step 51, control circuit 30 moves throttle valve 1 to the new position and a check takes place as to whether comparator 40 outputs stop signal 47. If stop signal 47 is not output, then current value 39 of motor current 31 lies below stop threshold value 46 and drive gear wheel 9 is still able to rotate. The search for lower or upper final position 11, 12 of drive gear wheel 9 therefore continues with step 50, and setpoint voltage 35 is varied further. If stop signal 47 is output, then current value 39 of motor current 31 is greater than stop threshold value 46, and drive gear wheel 9 is no longer able to rotate. Drive gear wheel 9 thus has reached its lower or upper final position 11, 12, and the method proceeds with step 52.

In step 52, measuring device 42 reduces stop threshold value 46 by a correction value that corresponds to correction distance 14. The correction value may be determined experimentally using a test series of prototypes of control circuit 30. With the aid of measuring technology, for example, current value 39 of motor current 31 may be determined on each prototype in which throttle value 1 is resting against one of mechanical stops 6, 7 while butterfly valve stem 10 is still undistorted. Using individual special current values 39, it is then possible to form an average value, which can be used as reduced stop threshold value 46.

Steps 53 and 54 correspond to steps 50 and 51, control circuit 30 now repositioning throttle valve 1 until current value 39 of motor current 31 has attained reduced stop threshold value 46. This makes it possible for position sensor 17, 18 to output a corrected potentiometer voltage 21, which may be used directly as limit value for one of mechanical stops 6, 7.

After throttle valve 1 has been repositioned, corrected potentiometer voltage 21 thus is able to be detected by measuring device 42 and stored directly in control memory 43, in step 55, for further utilization.

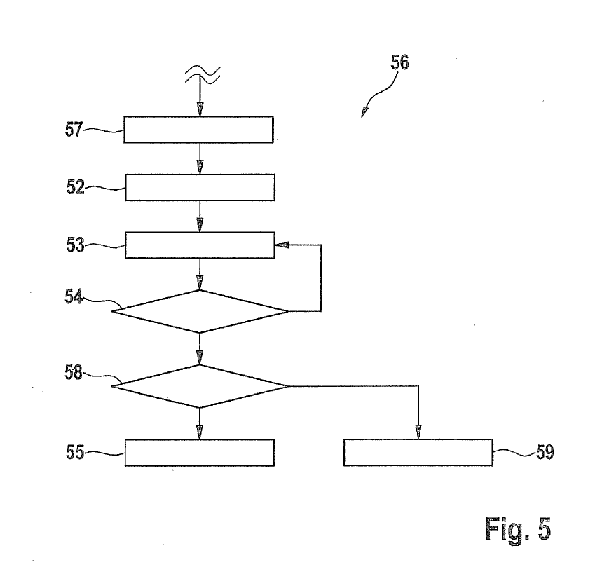

An improved correction of potentiometer voltage 21 will be described in the following text within the framework of an initialization method 56 according to a second exemplary embodiment of the present invention, based on FIG. 5. Elements in FIG. 5 that are identical to elements in FIG. 4 are denoted by the same reference numerals and not described again.

In initialization method 56, all steps up to step 51 are carried out analogously to program 48 from FIG. 4.

Following step 51, potentiometer voltage 21 is stored in measuring device 42 in step 57, when drive gear wheel 9 has attained its lower or upper final position 11, 12, respectively.

Steps 52 to 54 are then carried out as in initialization method 48 from FIG. 4.

Once current value 39 of motor current 31 has reached reduced stop threshold value 46 and the position of drive gear wheel 9 has been corrected, corrected potentiometer voltage 21 is subjected to a plausibility check in step 58. If corrected potentiometer voltage 21 is obviously free of errors, initialization method 56 is concluded by step 55 of the initialization method from FIG. 4. However, if an obvious error is discovered, initialization method 56 is concluded by outputting an error report in step 59.

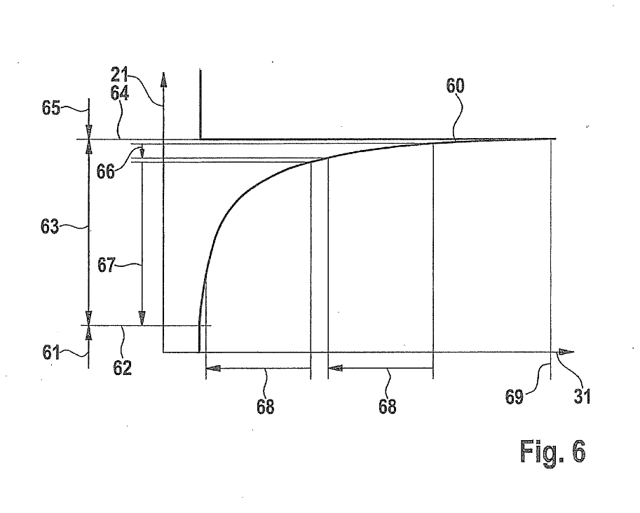

Characteristic curve 60 shown in FIG. 6, which plots resulting potentiometer voltage 21 over motor current 31 as a measure of the drive energy supplied to motor 26, is used to analyze corrected potentiometer voltage 21 for plausibilization purposes regarding obvious errors. The course of characteristic curve 60 may be recorded with the aid of measuring technology, using prototypes once again, for example.

The characteristic curve essentially has three ranges. A movement range 61 corresponds to a potentiometer voltage range in which the throttle valve is able to move freely within positioning range 5. Motor current 31 required to move drive gear wheel 9 in this range is essentially constant in all positions of drive gear wheel 9 and thus also constant across potentiometer voltage 21. Starting with a first limit potentiometer voltage 62, which corresponds to a potentiometer voltage 21 at which throttle valve 1 is loosely resting against one of the mechanical stops and butterfly valve shaft 10 is not distorted, marks the start of contact range 63 in which drive gear wheel 9 presses throttle valve 1 against one of mechanical stops 6, 7 with increasing force. In this range motor current 31 must be increased potentially via potentiometer voltage 21 in order to effect further movement of drive gear wheel 9. Butterfly valve shaft 10 is distorted in this contact range 63. However, the distortion of butterfly valve shaft 10 is limited and causes butterfly valve shaft 10 to fracture once a second limit potentiometer voltage 64 has been reached. Starting with the fracture, drive gear wheel 9 once more is able to move freely in a fracture range 65, in a similar manner as in movement range 61, without throttle valve 1 itself moving, however.

Decisive for the plausibilization of corrected potentiometer voltage 21 is contact range 63 of characteristic curve 60.

The farther drive gear wheel 9 has rotated beyond one of stop positions 3, 4, the smaller the reduction of potentiometer voltage 21 by a voltage amount 66, 67, through lowering of motor current 31 by a current amount 68. For example, if motor current 31 is lowered in very close proximity to maximum value 69 at the fracture limit, then a first voltage drop 66 of potentiometer voltage 21 will be smaller than a second voltage drop 67 of potentiometer voltage 21 that results from a lowering of motor current 31 in very close proximity to a minimum value of motor current 31.

Using this knowledge and assuming that motor current 31 should be selected very high for positioning throttle valve 1 while finding stop positions 3, 4, in order to overcome contamination 13, for the plausibilization it is assumed that the change in potentiometer voltage 21 is going to be small when stop threshold value 46 is lowered to correct potentiometer voltage 21 and when throttle valve 1 is repositioned based on lowered stop threshold value 46.

In step 58 of initialization method 56 from FIG. 5, it is therefore possible to form a difference from potentiometer voltage 21 stored in step 57 and potentiometer voltage 21 corrected in step 54; a check may furthermore take place as to whether the difference is small enough to be clearly free of errors. For example, a large difference may occur if gear 16 is also distorted when motor 26 transmits torque 32.

FIG. 7 shows a schematic view of a control circuit 30 from FIG. 3 for positioning throttle valve 1 using a device as recited in a second exemplary embodiment of the present invention. Similar to FIG. 3, this device is once again realized by a processor 22. Elements in FIG. 7 that are identical to elements in FIG. 3 are denoted by the same reference numerals and not described again.

In control circuit 30 of FIG. 7, second position sensor 29 on the side of butterfly valve shaft 10 lying opposite first position sensor 17, 18 is utilized to determine the point at which the distortion of butterfly valve shaft 10 has been resolved completely. This makes it possible to dispense with a reduction of stop threshold value 46, so that stop threshold value 46 may be fixedly defined from the outside.

Second position sensor 29 may likewise be a potentiometer 29, which has the same design as first potentiometer 17, 18. If a variation of motor current 31 merely leads to a variation of potentiometer voltage 21 from first position sensor 17, 18, butterfly valve shaft 10 is still distorted. However, if a variation of motor current 31 also leads to a variation of a second potentiometer voltage 70 from second position sensor 29, then this means that butterfly valve shaft 10 rotates at both ends and that the distortion has resolved itself.

FIG. 8 shows an initialization method 71 according to a third exemplary embodiment. Elements in FIG. 8 that are identical to elements in FIG. 4 are denoted by the same reference numerals and not described again.

Since stop threshold value 46 has been fixedly specified, step 52 for reducing stop threshold value 46 may be omitted in FIG. 8. The exemplary embodiments according to FIGS. 3 and 7 may also be combined with each other, however.

Step 116 replaces step 54 of initialization method 48 of FIG. 4, both steps essentially being executed in the same way. However, instead of checking whether modified stop threshold value 46 has been attained, in step 116 it is checked whether potentiometer voltage 70 varies at second position sensor 29 on the side of butterfly valve shaft 10 lying opposite first position sensor 17, 18. As long as potentiometer voltage 70 does not vary, butterfly valve shaft 10 is still distorted, so that the resetting of the drive energy, such as motor current 31, for instance, must be continued.

Corrected potentiometer voltage 21 resulting from step 116 may then be subjected to a plausibility check, once again based on the method according to FIG. 5.

According to the present invention, a measured position of a drive gear wheel while a throttle valve is striking a mechanical stop is shifted by a correction value into the operating position range of the throttle valve, in an effort to cancel the mechanical distortion of the butterfly valve shaft.

What is claimed is:

1. A method for determining information regarding a final position of an element of a gear, in particular a drive gear wheel, the information regarding the final position representing a stop position of a throttle valve at a mechanical stop, the method comprising:
moving the element from a starting position in a direction of the final position, until the element comes to a standstill despite a specified supply of drive energy;
determining information regarding a position of the element at standstill despite the supply of drive energy; and
determining the information regarding the final position in that information of a correction distance is subtracted from the information regarding the position of the element at standstill, counter to the direction of the final position at standstill despite the supply of drive energy.

2. A device for determining information regarding a final position of an element of a gear, in particular a drive gear wheel, the information regarding the final position representing a stop position of a throttle valve at a mechanical stop, the device comprising:
a drive device for moving the element from a starting position in a direction of the final position, until the element comes to a standstill despite a specified supply of drive energy; and
a measuring device for determining information regarding a position of the element at standstill despite the supply of drive energy;
the measuring device being configured to determine the information regarding the final position in that information regarding a correction distance is subtracted from the information regarding the position of the element at standstill, counter to the direction of the final position at standstill despite the supply of drive energy.

3. The device according to claim 2, wherein the measuring device has a comparison unit configured for determining standstill, for determining the drive energy, and for outputting an event indicating standstill, when the drive energy has reached or exceeds a threshold value.

4. The device according to claim 3, wherein:
the measuring device is configured to apply the information regarding the correction distance to reduce the threshold value,
the drive device is configured to return the element to the starting position, until the drive energy has reached or dropped below the reduced threshold value, and
the measuring device is configured to determine the information regarding the final position based on a position after the drive energy has reached or dropped below the reduced threshold value.

5. The device according to claim 4, wherein:
the measuring device is configured to store the information regarding the position of the element prior to being moved back to the starting position, and
the measuring device is configured to plausibilize the determined information regarding the final position based on a difference between the determined information regarding the final position and the stored information regarding the position.

6. The device according to claim 5, wherein the measuring device is configured for a plausibility check, to compare the difference to a difference stored in the measuring device.

7. The device according to claim 6, wherein the stored difference represents a movement of the element in a characteristic curve over the reduced drive energy, and the characteristic curve contrasts the drive energy to the information regarding the position of the element during standstill of the throttle valve.

8. A drive for a throttle valve, comprising:
a motor;
a gear, moved by the motor, for moving the throttle valve; and
a device according to claim 2 for determining information regarding the final position of the element of the gear when the throttle valve strikes a mechanical stop.

9. The drive according to claim 8, further comprising:
a butterfly valve shaft connected to the gear, on which the throttle valve (1) is mounted.

10. The drive according to claim 9, wherein the measuring device configured to determine the information regarding the correction distance is configured for:
measuring the information regarding the position of the gear at standstill despite the supply of drive energy; and
rotating the gear counter to the direction of the final position, until the butterfly valve shaft has been untwisted.
